(19) United States
(12) Patent Application Publication
(10) Pub. No.: US 2026/0155009 A1
(43) Pub. Date: Jun. 4, 2026

(54) PASSAGE CONTROL APPARATUS, SYSTEM, CONTROL METHOD OF PASSAGE CONTROL APPARATUS, AND STORAGE MEDIUM

(71) Applicant: NEC Corporation, Minato-ku, Tokyo (JP)

(72) Inventors: Masayoshi YAMAURA, Tokyo (JP); Tatsuki AKUTSU, Tokyo (JP); Osamu SAKAGUCHI, Tokyo (JP); Tomohiro HATAE, Tokyo (JP)

(73) Assignee: NEC Corporation, Minato-ku, Tokyo (JP)

(21) Appl. No.: 19/123,874

(22) PCT Filed: Nov. 14, 2022
(86) PCT No.: PCT/JP2022/042206

§ 371 Date: Apr. 24, 2025

(51) Int. Cl. G07C 9/37; G06V 20/52; G06V 40/16

(52) U.S. Cl. CPC G07C 9/37; G06V 20/52; G06V 40/161

(57) ABSTRACT

A passage control apparatus includes detection means, authentication control means, determination means, and control means. The detection means detects a plurality of users attempting to enter interior of the passage control apparatus by using image data acquired by capturing image of the plurality of users attempting to enter the interior. The authentication control means performs control related to authentication for each of the detected plurality of users. The determination means determines, based on respective authentication results of the plurality of users, whether or not the plurality of users who have entered the interior are permitted to pass through the passage control apparatus. The control means, in a case where it is determined that at least one or more of the plurality of users who have entered interior are not permitted to pass through the passage control apparatus, denies passage of the plurality of users who have entered the interior.

### TECHNICAL FIELD

The present invention relates to a passage control apparatus, a system, a control method of a passage control apparatus, and a storage medium.

### BACKGROUND ART

Widespread dissemination of services that make use of face recognition has begun. For example, the development of ticket gates compatible with face recognition is underway.

For example, Patent Literature 1 describes that a gate system capable of reliably determining unauthorized passage through a gate passage and preventing such unauthorized passage in advance is provided. The system of Patent Literature 1 includes a distance image sensor, an image data processing apparatus, and a gate control apparatus. The distance image sensor performs scanning of light over a two-dimensional region in the vicinity of a gate passage of the gate apparatus, and detects a distance value for each pixel within this two-dimensional region. The image data processing apparatus extracts a solid image based on a differential image that is generated from distance values for each pixel input from the distance image sensor, and determines a status of the solid that passes through the gate passage based on the extracted solid image. The gate control apparatus controls the gate apparatus based on an image determination result from an image determination unit.

### CITATION LIST

### Patent Literature

[PTL 1] Japanese Unexamined Patent Application Publication No. JP2011-065203

### SUMMARY OF INVENTION

### Technical Problem

As described in Patent Literature 1, it is necessary to prevent unauthorized passage through a gate. In recent years, the installation of wide gate apparatuses that allow easier passage for wheelchairs, baby strollers, and the like has been increasing, particularly as barrier-free ticket gates. However, in such wide gate apparatuses, unauthorized actions are more likely to occur, and it is therefore necessary to prevent unauthorized behavior specifically in these wide gate apparatuses.

It is a main object of the present invention to provide a passage control apparatus, a system, a control method of a passage control apparatus, and a storage medium, which contribute to preventing unauthorized passage by a user.

### Solution to Problem

According to a first aspect of the present invention, there is provided a passage control apparatus, including: a detection means that detects a plurality of users attempting to enter an interior of the passage control apparatus by using image data acquired by capturing an image of the plurality of users attempting to enter the interior; an authentication control means that performs control related to authentication for each of the detected plurality of users; a determination means that determines, based on respective authentication results of the plurality of users, whether or not the plurality of users who have entered the interior are permitted to pass through the passage control apparatus; and a control means that denies passage of the plurality of users who have entered the interior, in a case where it is determined that at least one or more of the plurality of users who have entered the interior are not permitted to pass through the passage control apparatus.

According to a second aspect of the present invention, there is provided a system, including: a server apparatus performing an authentication processing; and a passage control apparatus, wherein the passage control apparatus, including: a detection means that detects a plurality of users attempting to enter an interior of the passage control apparatus by using image data acquired by capturing an image of the plurality of users attempting to enter the interior; an authentication control means that performs control related to authentication for each of the detected plurality of users; a determination means that determines, based on respective authentication results of the plurality of users, whether or not the plurality of users who have entered the interior are permitted to pass through the passage control apparatus; and a control means that denies passage of the plurality of users who have entered the interior, in a case where it is determined that at least one or more of the plurality of users who have entered the interior are not permitted to pass through the passage control apparatus.

According to a third aspect of the present invention, there is provided a control method of a passage control apparatus, the control method including: detecting a plurality of users attempting to enter an interior of the passage control apparatus by using image data acquired by capturing an image of the plurality of users attempting to enter the interior; performing control related to authentication for each of the detected plurality of users; determining, based on respective authentication results of the plurality of users, whether or not the plurality of users who have entered the interior are permitted to pass through the passage control apparatus; and denying passage of the plurality of users who have entered the interior, in a case where it is determined that at least one or more of the plurality of users who have entered the interior are not permitted to pass through the passage control apparatus.

According to a fourth aspect of the present invention, there is provided A computer-readable storage medium storing a program causing a computer mounted on a passage control apparatus to perform processing for: detecting a plurality of users attempting to enter an interior of the passage control apparatus by using image data acquired by capturing an image of the plurality of users attempting to enter the interior; performing control related to authentication for each of the detected plurality of users; determining, based on respective authentication results of the plurality of users, whether or not the plurality of users who have entered the interior are permitted to pass through the passage control apparatus; and denying passage of the plurality of users who have entered the interior, in a case where it is determined that at least one or more of the plurality of users who have entered the interior are not permitted to pass through the passage control apparatus.

### Advantageous Effects of Invention

The individual aspects of the present invention provide a passage control apparatus, a system, a control method of a passage control apparatus, and a storage medium, which contribute to preventing unauthorized passage by a user. It is to be noted that the advantageous effect of the present invention is not limited to the above advantageous effect. The present invention may provide other advantageous effects, instead of or in addition to the above advantageous effect.

### BRIEF DESCRIPTION OF THE DRAWINGS

FIG. 1 is a diagram illustrating an outline of an example embodiment.

FIG. 2 is a flowchart illustrating an example of an operational outline of an example embodiment.

FIG. 3 is a diagram illustrating an example of a schematic configuration of an authentication system according to a first example embodiment.

FIG. 4 is a diagram illustrating an operation of the authentication system according to the first example embodiment.

FIG. 5 is a diagram illustrating the operation of the authentication system according to the first example embodiment.

FIG. 6 is a diagram illustrating the operation of the authentication system according to the first example embodiment.

FIG. 7 is a diagram illustrating the operation of the authentication system according to the first example embodiment.

FIG. 8 is a diagram illustrating an example of a processing configuration of a gate apparatus according to the first example embodiment.

FIG. 9 is a flowchart illustrating an example of an operation of the gate apparatus according to the first example embodiment.

FIG. 10 is a diagram illustrating an example of a processing configuration of a server apparatus according to the first example embodiment.

FIG. 11 is a diagram illustrating an example of a ticket management database according to the first example embodiment.

FIG. 12 is a diagram illustrating an example of an IC card management database according to the first example embodiment.

FIG. 13 is a diagram illustrating an example of a biometric information management database according to the first example embodiment.

FIG. 14 is a sequence diagram illustrating an example of an operation of the authentication system according to the first example embodiment.

FIG. 15 is a diagram illustrating an operation of the authentication system according to a second example embodiment.

FIG. 16 is a diagram illustrating an operation of the authentication system according to a third example embodiment.

FIG. 17 is a diagram illustrating an example of a hardware configuration of a gate apparatus according to the present application disclosed.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

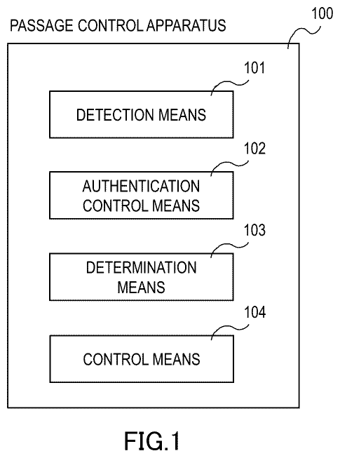

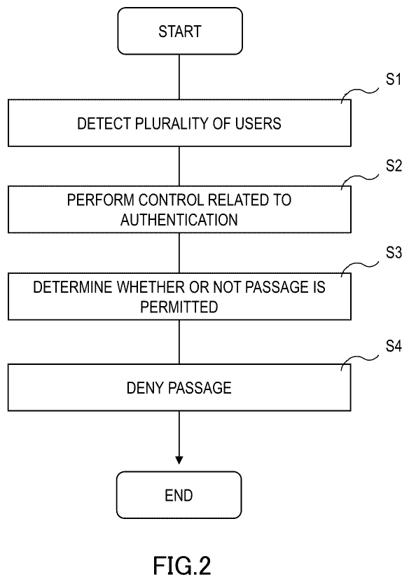

A passage control apparatus 100 according to an example embodiment includes a detection means 101, an authentication control means 102, a determination means 103, and a control means 104 (see FIG. 1). The detection means 101 detects a plurality of users attempting to enter an interior of the passage control apparatus by using image data acquired by capturing an image of the plurality of users attempting to enter the interior (step S1 in FIG. 2). The authentication control means 102 performs control related to authentication for each of the detected plurality of users (step S2). The determination means 103 determines, based on respective authentication results of the plurality of users, whether or not the plurality of users who have entered the interior are permitted to pass through the passage control apparatus (step S3). The control means 104, in a case where it is determined that at least one or more of the plurality of users who have entered the interior are not permitted to pass through the passage control apparatus, denies passage of the plurality of users who have entered the interior (step S4).

A passage control apparatus 100 detects a plurality of users attempting to enter its own apparatus by using image data. Accordingly, even in a case where a human sensor or the like does not function properly due to a plurality of users entering the interior, the passage control apparatus 100 can accurately grasp the number of users who have entered the interior of its own apparatus. The passage control apparatus 100 can permit passage of a plurality of users having correct authorization by controlling the passage of users using the number of users who have entered its own apparatus and the number of users who have successfully authenticated. In other words, the passage control apparatus 100 prevents unauthorized passage by users who do not have legitimate authorization. For example, in a case where two users enter the passage control apparatus 100 side by side, the passage control apparatus 100 permits their passage if the two users have authorization to pass through the apparatus. In contrast, if at least one of the two users does not have authorization to pass through the apparatus, the passage control apparatus 100 denies their passage.

Hereinafter, specific example embodiments will be described in more detail with reference to drawings.

### First Example Embodiment

A first example embodiment will be described in more detail with reference to drawings.

In the first example embodiment, an apparatus (an authentication terminal) including a gate as a means for restricting the passage of a user is described as an example of a passage control apparatus. It should be noted, however, that the means for controlling the passage of a user is not intended to be limited to a “gate”.

### System Configuration

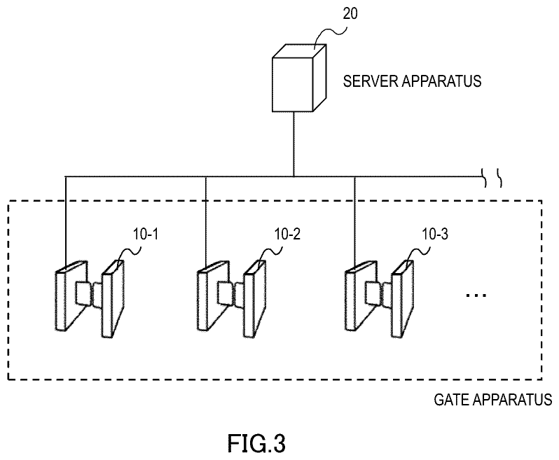

FIG. 3 is a diagram illustrating an example of a schematic configuration of an authentication system according to the first example embodiment. Referring to FIG. 3, the authentication system includes a plurality of gate apparatuses 10-1 to 10-3 and a server apparatus 20.

In the following description, unless there is a particular reason to distinguish the gate apparatuses 10-1 to 10-3 from each other, any one of these gate apparatuses 10-1 to 10-3 will simply be referred to as a “gate apparatus 10”. For other configurations as well, the respective configuration will be referred to representatively by the sign located to the left of the hyphen.

The individual gate apparatus 10 and the server apparatus 20 are configured to be capable of communicating with each other via a wired or wireless communication means. The server apparatus 20 may be installed within the same building as the gate apparatus 10, or the server apparatus 20 may be installed on a network (cloud).

The gate apparatus 10 is an apparatus that is installed, for example, in locations such as train stations, airports, event venues, or the like. The gate apparatus 10 performs control over the passage of a user. In the first example embodiment, the gate apparatus 10 is described as a ticket gate installed in a train station. It should be understood, of course, that the gate apparatus 10 is not intended to be limited to a ticket gate installed in a train station.

The gate apparatus 10 is an apparatus having a width that allows at least two or more users to pass through in parallel (side by side). In other words, the gate apparatus 10 is wider than a normal gate apparatus that has a width corresponding to a single person.

In the present application disclosed, it is assumed that a plurality of users arrive at an entrance of the gate apparatus 10 at substantially the same timing, and that the plurality of users are able to pass through the wide gate apparatus 10 at substantially the same timing. For example, in a case where two users enter the gate apparatus 10 side by side, and both of the two users have the authority to pass through the gate apparatus 10, the two users are allowed to pass through the gate apparatus 10 while remaining in the side-by-side state. It should be noted that the number of users entering the gate apparatus 10 side by side is not intended to be limited to “two”.

The server apparatus 20 is an apparatus that authenticates a person to be authenticated. The server apparatus 20 performs authentication of a user who attempts to pass through the gate apparatus 10. In a case where the user has qualification (authorization) to pass through the gate apparatus 10, the server apparatus 20 permits passage of the user. In a case where the user does not have qualification to pass through the gate apparatus 10, the server apparatus 20 rejects passage of the user.

The authentication system in the present application disclosed supports arbitrary authentication methods (various types of authentication methods). Specifically, the authentication system supports an authentication method that uses a two-dimensional barcode issued to the user who has previously purchased a ticket (fare ticket) (hereinafter referred to as “code authentication”).

Additionally, the authentication system supports an authentication method that uses a transportation system IC (Integrated Circuit) card (hereinafter referred to as “card authentication”).

Furthermore, the authentication system supports an authentication method that uses biometric information (biometric authentication).

Examples of biometric information include data (feature values) that are calculated from physical characteristics unique to an individual, such as a face, a fingerprint, a voiceprint, veins, a retina, or patterns (patterns) of an iris of the eye. Alternatively, the biometric information may be image data such as a face image or a fingerprint image. The biometric information may be anything that includes physical characteristics of a user as information. In the embodiments of the present application disclosed, a case where biometric information related to a human “face” (a face image or a feature value generated from the face image) is used will be described.

### Schematic Operation of System

Subsequently, with reference to the drawings, a schematic operation of the authentication system according to the first example embodiment will be described.

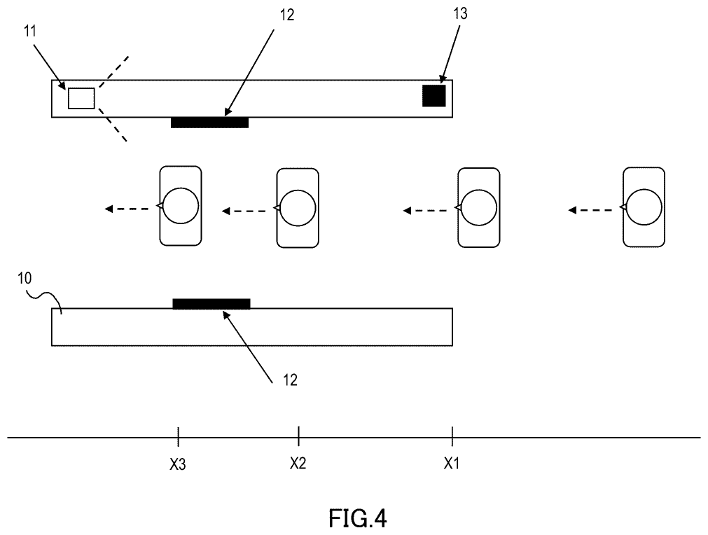

As shown in FIG. 4, the gate apparatus 10 includes a camera 11 installed in such a manner that the camera 11 is capable of capturing an image of a user walking toward its own apparatus. The gate apparatus 10 further includes a gate 12 in order to control the passage of the user.

As described above, the gate apparatus 10 is compatible with a plurality of authentication methods.

The user who wishes to pass through the gate using code authentication or card authentication uses a reader 13 that is installed at an entrance of the gate apparatus 10. The reader 13 reads a two-dimensional barcode presented by the user. The reader 13 also reads information from an IC (Integrated Circuit) chip mounted in a transportation system IC card presented by the user.

It should be noted that the reader 13 may be installed in either one of left or right housings located near the entrance of the gate apparatus 10, or may be installed in both the left and right housings.

The user who undergoes biometric authentication is able to pass through the gate apparatus 10 without using the reader 13, by means of so-called “face pass”.

Here, in order to pass through the gate apparatus 10, the user is required to make prior preparations such as purchasing a ticket. For example, the user purchases a ticket via a WEB (web) page or the like operated by a railway company. Alternatively, the user purchases a transportation system IC card and charges a predetermined amount of money to the card. Alternatively, the user performs system registration of biometric information (for example, a face image) and charges a predetermined amount of money.

It should be noted that these prior preparations are outside the scope of the present application disclosed and are obvious to those skilled in the art, and therefore, detailed description thereof will be omitted.

The gate apparatus 10 sets the user who attempts to pass through the gate as a person to be authenticated. The gate apparatus 10 sets the user who has reached the entrance (position X1 in FIG. 4) as the person to be authenticated.

The user who wishes to pass through the gate using code authentication brings a paper medium on which a two-dimensional barcode is printed, or a smartphone or the like on which the two-dimensional barcode is displayed, close to (in contact with) the reader 13 at position X1. The gate apparatus 10 reads out the content of the two-dimensional barcode using the reader 13. Specifically, the gate apparatus 10 reads out a “ticket ID” by decoding the two-dimensional barcode. The ticket ID is an ID used to uniquely identify a ticket purchased by the user.

The user who wishes to pass through the gate using card authentication brings a transportation system IC card close to (in contact with) the reader 13 at position X1. The gate apparatus 10 reads out a “card ID” from an IC chip of the transportation system IC card. The card ID is an ID used to uniquely identify the transportation system IC card.

The user who wishes to pass through the gate using biometric authentication enters into the interior of the gate apparatus 10. The gate apparatus 10 captures an image of the user who has reached position X1, and acquires biometric information (for example, a face image) of the user.

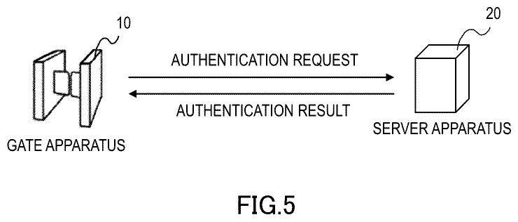

Upon acquiring authentication information such as a ticket ID, a card ID, or biometric information, the gate apparatus 10 transmits an authentication request including the authentication information and a terminal ID to the server apparatus 20 (see FIG. 5).

The terminal ID is an ID used to identify the gate apparatus 10 that is installed in a location such as a train station or the like. As the terminal ID, it is possible to use an MAC (Media Access Control) address or an IP (Internet Protocol) address of the gate apparatus 10.

It should be noted that the terminal ID is shared between the server apparatus 20 and the gate apparatus 10 by any arbitrary method. For example, a system administrator determines a terminal ID and sets the determined terminal ID in the gate apparatus 10. In addition, the system administrator sets the determined terminal ID and information related to the gate apparatus 10 in the server apparatus 20. The information related to the gate apparatus 10 includes, for example, a name of a station in which the gate apparatus 10 is installed.

The server apparatus 20 that has received the authentication request authenticates the person to be authenticated. Specifically, the server apparatus 20 determines whether or not the user (the person to be authenticated) has authority and qualification to pass through the gate apparatus 10.

In a case where an authentication request including a ticket ID is received, for example, the server apparatus 20 determines whether or not a ticket (fare ticket) corresponding to the acquired ticket ID is unused. In a case where the corresponding ticket is unused, the server apparatus 20 determines that authentication is successful. In a case where the corresponding ticket has already been used, the server apparatus 20 determines that authentication is a failure.

In a case where an authentication request including a card ID is received, for example, the server apparatus 20 determines that authentication is successful if a balance of the transportation system IC card corresponding to the acquired card ID is equal to or greater than a base fare. If the balance of the corresponding transportation system IC card is less than the base fare, the server apparatus 20 determines that authentication is a failure.

In a case where an authentication request including biometric information is received, the server apparatus 20 identifies the person to be authenticated by performing a matching process using the acquired biometric information. For example, if a balance of the identified person to be authenticated (a balance of the account of the person to be authenticated) is equal to or greater than a base fare, the server apparatus 20 determines that authentication is successful. If the balance of the identified person to be authenticated (the balance of the account of the person to be authenticated) is less than the base fare, the server apparatus 20 determines that authentication is a failure.

The server apparatus 20 transmits an authentication result (authentication success, authentication failure) to the gate apparatus 10.

Upon receiving the authentication result, the gate apparatus 10 updates information related to users who are allowed to pass through the gate 12. The gate apparatus 10 manages the number of users who have been successfully authenticated as a “number of persons permitted to pass through the gate.” Specifically, in a case where an authentication success is received, the gate apparatus 10 adds “1” to the number of persons permitted to pass through the gate. In contrast, in a case where an authentication failure is received, the gate apparatus 10 does not update the number of persons permitted to pass through the gate.

The user who has reached position X1 proceeds through the interior of the gate apparatus 10. In a case where the user arrives just in front of the position of the gate 12 (position X2 in FIG. 4), the gate apparatus 10 determines whether or not the user is permitted to pass through the gate.

Specifically, the gate apparatus 10 detects a user who has arrived at a predetermined position within the own apparatus (for example, just in front of the position of the gate 12; position X2), by analyzing image data obtained from the camera 11. More specifically, the gate apparatus 10 detects the user who has reached position X1 by using an index related to the size of a face image included in the image data acquired by capturing the user.

In a case where the user who has reached the position X2 is detected, the gate apparatus 10 determines whether or not the user is permitted to pass through the gate, using the number of users who have reached the position X2 (hereinafter referred to as the number of persons who have reached the gate) and the number of persons permitted to pass through the gate.

More specifically, in a case where the number of persons who have reached the gate is equal to or less than the number of persons permitted to pass through the gate, the gate apparatus 10 determines that the user is “permitted to pass through the gate” with respect to the determination on whether or not the user is permitted to pass through the gate. For example, as shown in FIG. 4, in a case where one user who enters the gate apparatus 10 is determined as “authentication success,” the number of persons permitted to pass through the gate is “1.” In addition, in a case where the user reaches the position X2, the number of persons who have reached the gate also becomes “1.” Accordingly, it is determined that the user is permitted to pass through the gate.

It should be noted that, in FIG. 4, in a case where a user who enters the gate apparatus 10 is determined as “authentication failure,” the number of persons permitted to pass through the gate is “0.” In addition, in a case where the user reaches the position X2, the number of persons who have reached the gate becomes “1.” In this case, since the number of persons who have reached the gate is greater than the number of persons permitted to pass through the gate, the user is determined as “not permitted to pass through the gate.”

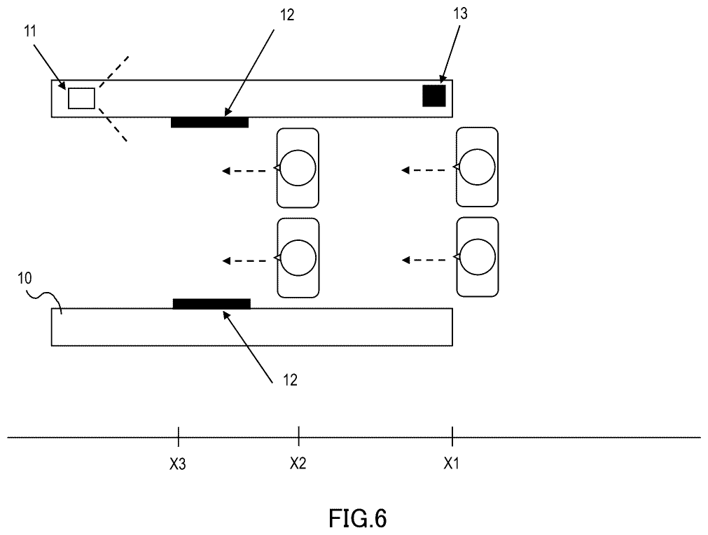

Further, as shown in FIG. 6, consider a case where two users enter the gate apparatus 10 side by side. In a case where the authentication results of the two users are both “authentication success,” the number of persons permitted to pass through the gate is “2.” In a case where the two users reach the position X2, the number of persons who have reached the gate becomes “2.” Accordingly, since the number of persons permitted to pass through the gate and the number of persons who have reached the gate are equal, the two users are determined as permitted to pass through the gate.

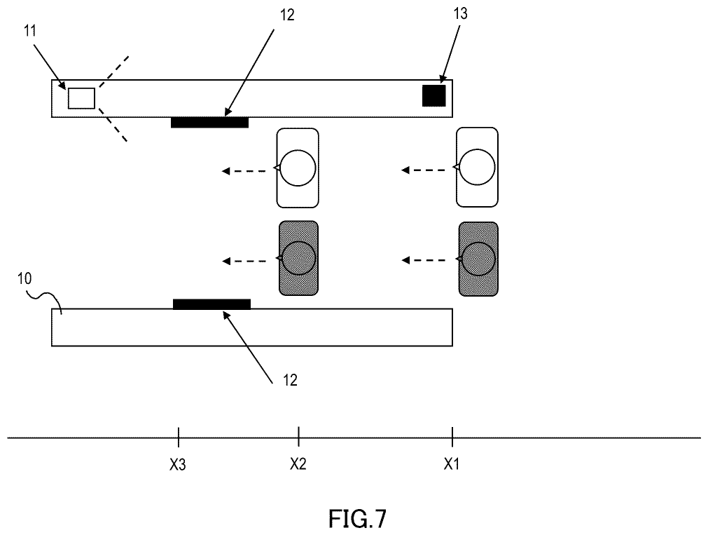

Next, consider a case where the authentication of one of the two users fails. In this case, for example, as shown in FIG. 7, a user determined as “authentication success” (a white-colored user) and a user determined as “authentication failure” (a gray-colored user) enter the interior of the gate apparatus 10. Since the authentication of one user is successful, the number of persons permitted to pass through the gate managed by the gate apparatus 10 is “1.” In a case where the two users reach the position X2, the number of persons who have reached the gate becomes “2.” Accordingly, since the number of persons who have reached the gate is greater than the number of persons permitted to pass through the gate, the two users are determined as not permitted to pass through the gate.

In a case where each of the users who have reached the position X2 at substantially the same timing is determined as “permitted to pass through the gate,” the gate apparatus 10 maintains the open state of the gate 12 and permits each user to pass through the gate. In a case where at least one of the users who have reached the position X2 at substantially the same timing is determined as “not permitted to pass through the gate,” the gate apparatus 10 closes the gate 12 and denies the users who have reached the position X2 from passing through the gate. In the examples of FIG. 4, FIG. 6, and FIG. 7, the gate 12 is closed in the case of FIG. 7.

The gate apparatus 10 detects the user who has passed through the gate 12 by using image data acquired from the camera 11. Specifically, the gate apparatus 10 detects the user who has reached the position X3 by analyzing the image data acquired from the camera 11. In a case where the user who has reached the position X3 is detected, the gate apparatus 10 subtracts the number of users who have reached the position X3 (hereinafter referred to as the number of users who have passed through the gate) from the number of persons permitted to pass through the gate.

For example, in the case of FIG. 4, the number of persons permitted to pass through the gate is set to “1” at the timing at which the authentication of the user succeeds, and is set to “0” at the timing at which the user is detected at the position X3 (the timing at which the user has passed through the gate 12).

In the example of FIG. 6, the number of persons permitted to pass through the gate is set to “2” at the respective timings at which the authentication of each of the two users succeeds, and in the case where the two users are detected at the position X3 (the timing at which the users have passed through the gate 12), the number of persons permitted to pass through the gate is set to “0.”

Next, details of the individual apparatuses included in the authentication system according to the first example embodiment will be described.

### Gate Apparatus

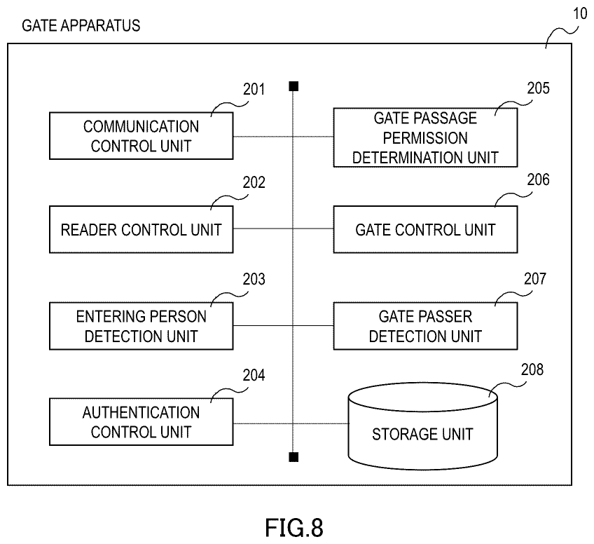

FIG. 8 is a diagram illustrating an example of a processing configuration (processing modules) of the individual gate apparatus 10 according to the first example embodiment. Referring to FIG. 8, the gate apparatus 10 includes a communication control unit 201, a reader control unit 202, an entering person detection unit 203, an authentication control unit 204, a gate passage permission determination unit 205, a gate control unit 206, a gate passer detection unit 207, and a storage unit 208.

The communication control unit 201 is means for controlling communication with other apparatuses. For example, the communication control unit 201 receives data (packets) from the server apparatus 20. In addition, the communication control unit 201 transmits data to the server apparatus 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The reader control unit 202 is means for controlling the reader 13. The reader control unit 202 controls the reader 13 to acquire a ticket ID from a two-dimensional barcode presented by a user (person to be authenticated). Further, the reader control unit 202 acquires a card ID from an IC chip of a transportation system IC card presented by the user.

The reader control unit 202 passes the read ticket ID or card ID to the authentication control unit 204.

The entering person detection unit 203 is means for detecting a user who attempts to enter the gate apparatus 10. The entering person detection unit 203 detects at least one or more users who attempt to enter the interior of the gate apparatus 10, using image data acquired by capturing at least one or more users who attempt to enter the interior of the gate apparatus 10. In the examples of FIG. 4 and FIG. 6, the entering person detection unit 203 detects the user who has reached the position X1.

The entering person detection unit 203 acquires image data captured by the camera 11 at regular or predetermined timings. The entering person detection unit 203 detects the user who has reached the entrance of the gate apparatus 10 by analyzing the image data.

The entering person detection unit 203 attempts to detect a face region from image data acquired from the camera 11. It should be noted that the processing of detecting a face region by the entering person detection unit 203 can employ an existing technology, and therefore, a detailed description thereof is omitted. For example, the entering person detection unit 203 may extract a face region (face image) from the image data using a trained model learned by a CNN (Convolutional Neural Network). Alternatively, the entering person detection unit 203 may detect the face region using a technique such as template matching.

In a case where at least one or more face regions are detected in the image data, the entering person detection unit 203 calculates an index indicating the size of each face region (hereinafter referred to as a face region size). For example, the entering person detection unit 203 calculates the area of each face region (the number of pixels constituting the face region). Alternatively, the entering person detection unit 203 calculates the interocular distance of each face region (the number of pixels between both eyes).

The entering person detection unit 203 determines that the user has reached the position X1 in a case where the calculated face region size falls within a predetermined range. In other words, even if a human face appears in the image data, in a case where the face region size is smaller than a predetermined value (a first threshold) or larger than a predetermined value (a second threshold), it is determined that the user has not reached the position X1. In the former case, the user appearing in the image data is located farther from the gate apparatus 10 than the position X1, and in the latter case, the user appearing in the image data is determined to have passed the position X1.

Since the detection of the user is performed by analyzing the image data, in a case where two users enter the gate apparatus 10 side by side, the entering person detection unit 203 can recognize, from the analysis of the image data, the fact that the two users have reached the position X1.

It should be noted that there are individual differences in the size of the user's face. Accordingly, the position of X1 shown in FIG. 4 or the like may slightly vary back and forth. A system administrator or the like determines the two thresholds or the like while taking the individual differences into consideration.

As described above, the entering person detection unit 203 detects a plurality of users who attempt to enter the interior, based on indexes indicating a size of a face region, the face region being included in the image data, of each of the plurality of users attempting to enter the interior.

In a case where the entering person detection unit 203 detects the user who has reached the entrance of the gate apparatus 10, the entering person detection unit 203 extracts a face region (face image) of the detected user from the image data. The entering person detection unit 203 passes the extracted face image to the authentication control unit 204. It should be noted that, as described above, in a case where two users arrive side by side at the entrance of the gate apparatus 10, face images of the two users are passed to the authentication control unit 204.

The authentication control unit 204 is means for performing control related to user authentication. The authentication control unit 204 performs control related to authentication for each of a plurality of users detected by the entering person detection unit 203.

The authentication control unit 204 transmits an authentication request including authentication information (ticket ID, card ID, biometric information) and a terminal ID to the server apparatus 20. For example, the authentication control unit 204 transmits an authentication request including a ticket ID or a card ID acquired from the reader control unit 202 to the server apparatus 20. Further, the authentication control unit 204 transmits an authentication request including a face image (biometric information) acquired from the entering person detection unit 203 to the server apparatus 20.

It should be noted that, for a user who undergoes code authentication or card authentication, an authentication request including the ticket ID or the card ID as the authentication information of the user is transmitted to the server apparatus 20, and an authentication request including biometric information of the user is also transmitted to the server apparatus 20. In this case, the authentication request including the biometric information is determined as a failure. This is because the user who does not wish to be authenticated using biometric authentication selects code authentication or card authentication.

In a case where a plurality of face images are simultaneously acquired from the entering person detection unit 203, the authentication control unit 204 transmits the same number of authentication requests as the number of the acquired face images to the server apparatus 20. For example, in a case where two face images are acquired, the authentication control unit 204 transmits two authentication requests to the server apparatus 20, each of the authentication requests including a face image of a user.

The authentication control unit 204 receives an authentication result (authentication success, authentication failure) from the server apparatus 20.

In a case where authentication success is received, the authentication control unit 204 increments the number of persons permitted to pass through the gate. In a case where authentication failure is received, the authentication control unit 204 does not perform any particular processing.

The gate passage permission determination unit 205 is means for determining whether or not a user who has reached the gate 12 is permitted to pass through the gate. The gate passage permission determination unit 205 determines whether or not a plurality of users who have entered the interior are permitted to pass through the gate 12, based on the respective authentication results of the plurality of users (at least one or more users). In the examples of FIG. 4 and FIG. 6, the gate passage permission determination unit 205 determines whether or not a user who has reached the position X2 is permitted to pass through the gate.

The gate passage permission determination unit 205 detects the user who has reached the position X2 by using a method similar to that of the entering person detection unit 203. The gate passage permission determination unit 205 detects the user who has reached the position X2 by calculating a face region size for a face region included in the image data, and performing a threshold processing on the calculated face region size.

In a case where the user who has reached the position X2 is detected, the gate passage permission determination unit 205 calculates the number of users who have reached the gate (the number of persons who have reached the gate). For example, in a case where two users reach the position X2, the number of persons who have reached the gate is calculated as “2.”

The gate passage permission determination unit 205 determines whether or not a plurality of users who have entered the interior of the gate apparatus 10 are permitted to pass through the gate 12, based on the number of users who have entered the interior and the number of users determined as authentication success. That is, the gate passage permission determination unit 205 determines whether or not the persons who have reached the gate are permitted to pass through the gate, based on the number of persons who have reached the gate as calculated above and the number of persons permitted to pass through the gate.

Specifically, the gate passage permission determination unit 205 determines that the user (at least one or more users) who has reached the gate 12 is permitted to pass through the gate, in a case where the number of persons who have reached the gate is equal to or less than the number of persons permitted to pass through the gate.

On the other hand, in a case where the number of persons who have reached the gate is greater than the number of persons permitted to pass through the gate, the gate passage permission determination unit 205 determines that the user (at least one or more users) who has reached the gate 12 is not permitted to pass through the gate.

In a case where it is determined that the user is not permitted to pass through the gate, the gate passage permission determination unit 205 notifies the gate control unit 206 of that fact. Further, in a case where it is determined that the user is not permitted to pass through the gate, the gate passage permission determination unit 205 may notify the user that the gate 12 cannot be passed, and may also provide guidance to the user to proceed to a booth or the like where a station attendant is standing by.

In a case where it is determined that the user is permitted to pass through the gate, the gate passage permission determination unit 205 does not perform any particular processing.

The gate control unit 206 is means for controlling the gate 12. Specifically, in a case where at least one or more users among a plurality of users who have entered the interior of the gate apparatus 10 is determined not to be permitted to pass through the gate 12, the gate control unit 206 closes the gate 12. That is, in a case where the gate control unit 206 receives a notification of gate passage denial from the gate passage permission determination unit 205, the gate control unit 206 refuses passage of the user who has entered the gate apparatus 10.

The gate passer detection unit 207 is means for detecting a user who has passed through the gate 12. In the examples of FIG. 4 and FIG. 6, the gate passer detection unit 207 detects a user who has reached the position X3.

The gate passer detection unit 207 detects the user who has reached the position X3 by using a method similar to that of the entering person detection unit 203. The gate passer detection unit 207 detects the user who has reached the position X3 by calculating a face region size for a face region appearing in the image data and performing a threshold processing on the calculated face region size.

In a case where the user who has reached the position X3 is detected, the gate passer detection unit 207 calculates the number of users who have reached the position X3 (the number of persons who have passed through the gate). The gate passer detection unit 207 updates the number of persons permitted to pass through the gate by subtracting the calculated number of persons who have passed through the gate from the number of persons permitted to pass through the gate.

The storage unit 208 is means for storing information necessary for the operation of the gate apparatus 10.

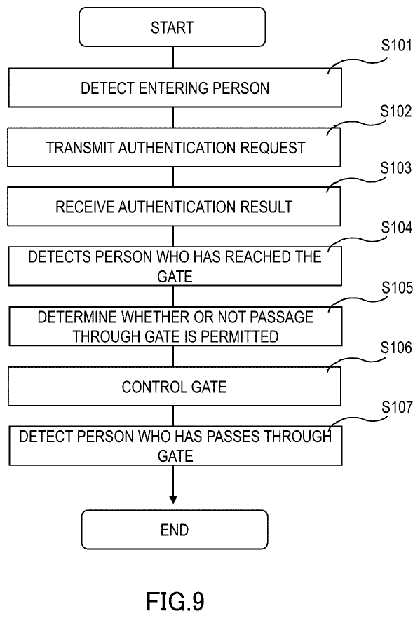

The operation of the gate apparatus 10 described above is summarized in the flowchart shown in FIG. 9.

The gate apparatus 10 detects an entering person who enters the interior of the own apparatus (step S101). The gate apparatus 10 detects the entering person using image data acquired by capturing the user with the camera 11.

The gate apparatus 10 transmits an authentication request including authentication information (ticket ID, card ID, biometric information) to the server apparatus 20 (step S102).

The gate apparatus 10 receives an authentication result (authentication success, authentication failure) (step S103). In a case where authentication success is received, the gate apparatus 10 updates the number of persons permitted to pass through the gate (increments the number of persons permitted to pass through the gate).

The gate apparatus 10 detects the user who has reached the gate 12 installed in the own apparatus (detects a person who has reached the gate; step S104).

In a case where the user who has reached the gate 12 is detected, the gate apparatus 10 determines whether or not the user is permitted to pass through the gate (step S105).

The gate apparatus 10 controls the gate 12 in accordance with the determination result of whether or not gate passage is permitted. In a case where the person who has reached the gate is determined not to be permitted to pass through the gate, the gate apparatus 10 closes the gate 12 (refuses passage of the person who has reached the gate).

The gate apparatus 10 detects a person who has passed through the gate (step S107). In a case where the person who has passed through the gate is detected, the gate apparatus 10 updates the number of persons permitted to pass through the gate.

### Server Apparatus

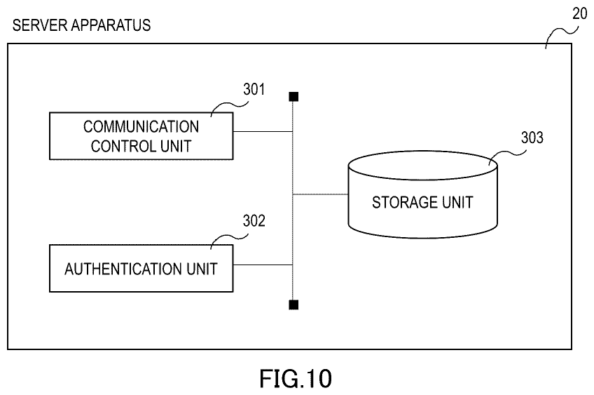

FIG. 10 is a diagram illustrating an example of a processing configuration (processing modules) of the server apparatus 20 according to the first example embodiment. Referring to FIG. 10, the server apparatus 20 includes a communication control unit 301, an authentication unit 302, and a storage unit 303.

The communication control unit 301 is means for controlling communication with other apparatuses. For example, the communication control unit 301 receives data (a packet) from the gate apparatus 10. In addition, the communication control unit 301 transmits data to a gate apparatus 10. The communication control unit 301 gives data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

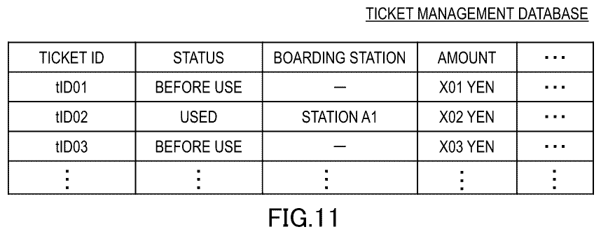

The server apparatus 20 includes a database for authenticating a person to be authenticated. Specifically, the server apparatus 20 includes a ticket management database for code authentication, an IC card management database for card authentication, and a biometric information management database for biometric authentication (see FIGS. 11 to 13).

The ticket management database is a database for managing tickets that have been sold to users. As shown in FIG. 11, the ticket management database stores a ticket ID, a status of the sold ticket, a boarding station, a purchase amount, and the like in association with each other.

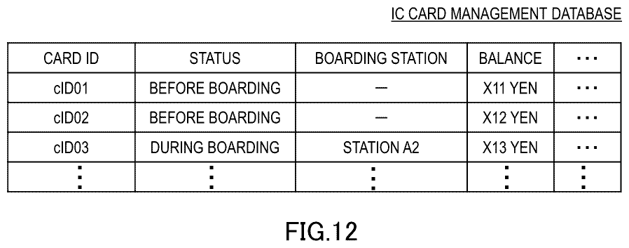

The IC card management database is a database for managing transportation system IC cards possessed by users. As shown in FIG. 12, the IC card management database stores a card ID, a status of the transportation system IC card, a boarding station, a balance (charged amount), and the like in association with each other.

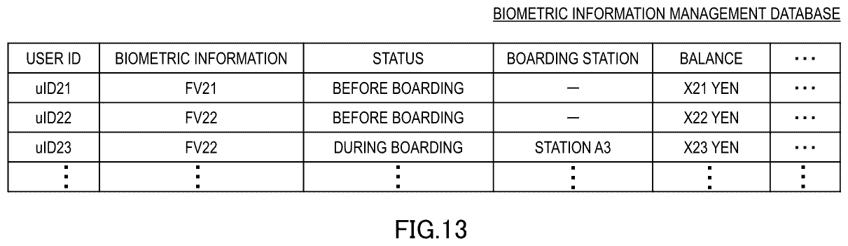

The biometric information management database is a database for managing biometric information of users (for example, a feature value generated from a face image). As shown in FIG. 13, the biometric information management database stores a user ID, biometric information (feature value), a status of the user, a boarding station, a balance (charged amount), and the like in association with each other.

It should be noted that a method of generating each database and the like is different from the spirit of the present application disclosed, and therefore a detailed description thereof will be omitted.

For example, the server apparatus 20 provides a website for selling tickets to a user. The server apparatus 20 generates a ticket ID for a ticket sold to the user and issues a two-dimensional barcode in which the ticket ID has been converted, to the user (a terminal possessed by the user). The server apparatus 20 registers the generated ticket ID in the ticket management database.

Alternatively, the server apparatus 20 acquires a card ID and the like of a transportation system IC card sold to a user from a terminal installed at a station or the like, and registers the information in the IC card management database. Further, in a case where cash is charged to the transportation system IC card, the server apparatus 20 updates the balance in the IC card management database.

Alternatively, the server apparatus 20 may provide a GUI (Graphical User Interface) or the like that enables the user to perform system registration (biometric information). For example, the server apparatus 20 may acquire a face image of the user using a web page or the like for system registration. The server apparatus 20 may generate a feature value from the acquired face image and register it in the biometric information management database together with a user ID. Alternatively, the server apparatus 20 may allow the user to charge cash via the above-mentioned web page or the like.

The authentication unit 302 is means for processing an authentication request received from the gate apparatus 10. In a case where the authentication unit 302 receives an authentication request, the authentication unit 302 acquires authentication information (ticket ID, card ID, biometric information) from the authentication request.

The authentication unit 302 performs processing in accordance with the acquired authentication information.

In a case where a ticket ID is acquired, the authentication unit 302 processes the authentication request using the ticket management database. The authentication unit 302 searches the ticket management database using the ticket ID acquired from the authentication request as a key.

In a case where no entry corresponding to the acquired ticket ID exists, the authentication unit 302 sets “authentication failure” as the authentication result.

In a case where an entry corresponding to the acquired ticket ID exists, the authentication unit 302 refers to the status field of the corresponding entry. In a case where the status of the corresponding ticket is “before use,” the authentication unit 302 sets “authentication success” as the authentication result. In addition, the authentication unit 302 respectively sets the status of the corresponding entry to “used” and the name of the station at which the gate apparatus 10, which is the source of the authentication request, is installed in the boarding station field.

If the status of the corresponding ticket is “used”, the authentication unit 302 sets “authentication failure” as the authentication result.

In a case where a card ID is acquired, the authentication unit 302 processes the authentication request using the IC card management database. The authentication unit 302 searches the IC card management database using, as a key, the card ID acquired from the authentication request.

In a case where an entry corresponding to the acquired card ID does not exist, the authentication unit 302 sets “authentication failure” as the authentication result.

In a case where an entry corresponding to the acquired card ID exists, the authentication unit 302 refers to the status field of the corresponding entry. If the status of the corresponding transportation system IC card is “before boarding” and the balance is equal to or greater than the minimum fare, the authentication unit 302 sets “authentication success” as the authentication result. In addition, the authentication unit 302 sets “during boarding” as the status of the corresponding entry, and sets, in the boarding station field, the station name where the gate apparatus 10, which is the source of the authentication request, is installed.

If the status of the corresponding transportation system card is “during boarding” or the balance is less than the minimum fare, the authentication unit 302 sets “authentication failure” as the authentication result.

In a case where biometric information is acquired, the authentication unit 302 processes the authentication request using the biometric information management database.

Specifically, the authentication unit 302 generates a feature value from the face image included in the authentication request. It is noted that existing techniques can be used for the processing of generating the feature value, and therefore a detailed description thereof is omitted. For example, the authentication unit 302 extracts eyes, nose, mouth, and the like from the face image as feature points. Thereafter, the authentication unit 302 calculates, as feature value, the positions of the respective feature points and the distances between the feature points, and generates a feature vector (vector information characterizing the face image) composed of a plurality of feature values.

Thereafter, the authentication unit 302 sets the generated feature value as the target to be matched, and performs one-to-N (N is a positive integer, and the same shall apply hereinafter) matching with a plurality of feature values registered in the biometric information management database.

The authentication unit 302 calculates a similarity degree between the feature value (feature vector) to be matched and each of the plurality of registered feature values. For the individual similarity, the chi-squared distance, the Euclidean distance, and so on may be used. A longer distance represents a lower similarity, and a shorter distance represents a higher similarity.

If no feature value having a similarity degree equal to or greater than a predetermined value is registered in the biometric information management database, the authentication unit 302 sets “authentication failure” as the authentication result.

If a feature value having a similarity degree equal to or greater than a predetermined value is registered in the biometric information management database, the authentication unit 302 determines whether or not the user identified through the matching processing is qualified to pass through the gate apparatus 10.

Specifically, if the status of the identified user is “before boarding” and the balance is equal to or greater than the minimum fare, the authentication unit 302 sets “authentication success” as the authentication result. In addition, the authentication unit 302 sets “boarding” as the status of the corresponding entry, and sets, in the boarding station field, the station name where the source of the authentication request (the gate apparatus 10) is installed.

If the status of the user identified through the matching processing is “boarding” or the balance is less than the minimum fare, the authentication unit 302 sets “authentication failure” as the authentication result.

The authentication unit 302 notifies the gate apparatus 10 of the authentication result (authentication success, authentication failure). In the case of authentication success, the authentication unit 302 transmits a positive response indicating the same to the gate apparatus 10. In the case of authentication failure, the authentication unit 302 transmits a negative response indicating the same to the gate apparatus 10.

It is noted that a description related to the system operation in the case where a user passes from inside the ticket gate to the outside through the gate apparatus 10, and a description related to the updates of various types of databases, and the like (for example, fare settlement), is outside the scope of the present application disclosed, and therefore a description thereof is omitted. The server apparatus 20 may perform fare settlement in accordance with attributes of the person to be authenticated, and the like (for example, a person with disabilities, a child, or an elderly person who is eligible for fare discounts). In addition, these attributes may be stored in respective types of databases.

The storage unit 303 stores various types of information necessary for the operation of the server apparatus 20.

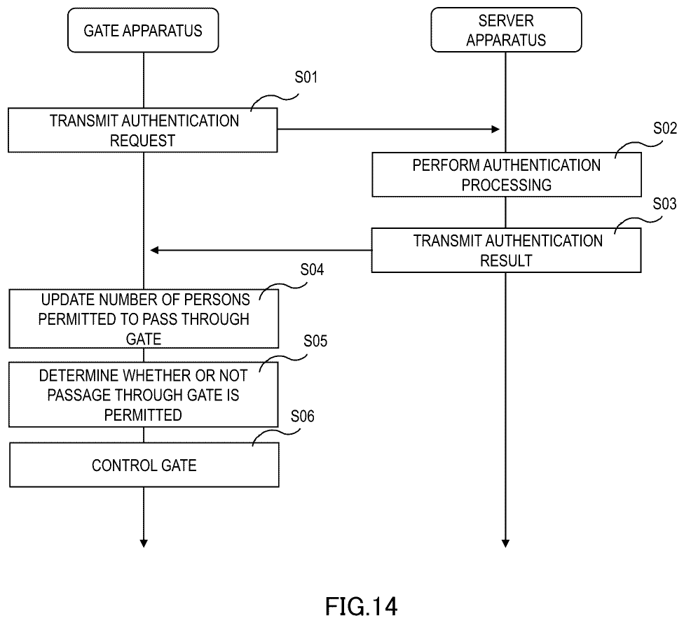

Subsequently, a description will be given of an operation of the authentication system according to the first example embodiment with reference to the drawings. FIG. 14 is a sequence diagram illustrating an example of the operation of the authentication system according to the first example embodiment.

In a case where the gate apparatus 10 acquires authentication information of the person to be authenticated, the gate apparatus 10 transmits an authentication request including the authentication information to the server apparatus 20 (step S01).

In response to reception of the authentication request, the server apparatus 20 performs authentication processing (step S02). The server apparatus 20 performs authentication processing in accordance with the authentication information included in the authentication request.

The server apparatus 20 transmits an authentication result (authentication success, authentication failure) to the gate apparatus 10 (step S03).

In a case where a positive response (authentication success) is received, the gate apparatus 10 updates the number of persons permitted to pass through the gate (step S04).

In a case where the person to be authenticated arrives just in front of the position of the gate 12, the gate apparatus 10 determines whether or not the person who has arrived at the gate is permitted to pass through, based on the number of persons permitted to pass through the gate and the number of persons who have arrived at the gate (step S05).

The gate apparatus 10 controls the gate 12 based on the determination result as to whether or not passage through the gate is permitted (step S06).

### Variation According to the First Example Embodiment

In the above example embodiment, the gate apparatus 10 equipped with a gate is described as an example of a passage control apparatus. However, the means for restricting the passage of a user (the person to be authenticated) may be other means.

For example, in a case where it is determined that the person to be authenticated is not permitted to pass through the own apparatus, the passage control apparatus may reject the passage of the person to be authenticated who does not have legitimate authorization by notifying the person of a message indicating that fact. Alternatively, in a case where the passage control apparatus detects a person to be authenticated who does not have legitimate authorization, the passage control apparatus may notify a terminal possessed by a staff member of a station or the like of that fact. The staff member who has received the notification may reject (prevent) the passage of the person to be authenticated (through the passage control apparatus). That is, the passage control apparatus in the present application disclosed may be a gateless (flapless) apparatus that is not equipped with a gate.

As described above, the gate apparatus 10 (passage control apparatus) according to the first example embodiment counts the number of entering persons using the size of a face, the interocular distance, or the like of a person entering the own apparatus. The gate apparatus 10 requests the server apparatus 20 to authenticate the entering person. The server apparatus 20 verifies, by any authentication means, whether or not the entering person (the person to be authenticated) has legitimate authorization (a ticket) to pass through the gate. The gate apparatus 10 permits the entering persons to pass through the gate in a case where the number of entering persons matches the number of users determined as having succeeded in authentication. As a result, it becomes possible for users (a plurality of users) who often enter the gate apparatus 10 side by side, such as a parent and child, to pass through the gate. That is, in a gate apparatus having a normal width, side-by-side gate passage by a plurality of persons is, in principle, not allowed; however, in the gate apparatus 10 according to the first example embodiment, side-by-side gate passage by a plurality of persons is allowed. In addition, the gate apparatus 10 can permit passage through the gate 12 by a user having correct authority by controlling the gate 12 based on the number of users who have entered the own apparatus and the number of users who have succeeded in authentication. In other words, the gate apparatus 10 prevents unauthorized gate passage by a user who does not have legitimate authorization.

### Second Example Embodiment

Subsequently, a detailed description will be given of a second example embodiment with reference to the drawings.

In the first example embodiment, it is described that authentication requests are separately transmitted for a plurality of users who have arrived at the entrance (position X1) of the gate apparatus 10. In the second example embodiment, it will be described that a collective authentication request is transmitted for a plurality of users who have arrived at the entrance of the gate apparatus 10 at the same timing.

It should be noted that a configuration of the authentication system according to the second example embodiment can be the same as that of the first example embodiment, and therefore a description corresponding to FIG. 3 is omitted.

The following description will be made with a focus on the difference between the first example embodiment and the second example embodiment.

The entering person detection unit 203 of the gate apparatus 10 according to the second example embodiment, in a case where two or more users have arrived at the entrance of the gate apparatus 10 simultaneously, passes the face images of the two or more users to the authentication control unit 204. For example, in a case where two users arrive side by side at the entrance (position X1) of the gate apparatus 10, the entering person detection unit 203 passes the respective face images of the two users to the authentication control unit 204.

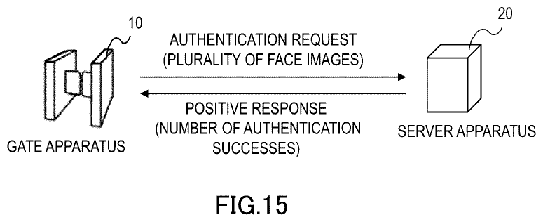

The authentication control unit 204, which has acquired a plurality of face images, transmits an authentication request (a single authentication request) including the plurality of face images to the server apparatus 20 (see FIG. 15).

In a case where an authentication request includes a plurality of pieces of biometric information (face images), the authentication unit 302 of the server apparatus 20 performs authentication processing (biometric authentication) for each of the plurality of face images.

The authentication unit 302 collectively transmits the authentication results for the respective face images to the gate apparatus 10. In a case where authentication fails for each (all) of the face images included in the authentication request, the authentication unit 302 transmits a negative response indicating that fact to the gate apparatus 10.

In a case where authentication is successful for at least one or more of the plurality of face images included in the authentication request, the authentication unit 302 transmits a positive response indicating authentication success to the gate apparatus 10. At that time, the authentication unit 302 notifies the gate apparatus 10 of the number of persons to be authenticated who have been determined as successful in authentication (hereinafter referred to as “the number of persons who have succeeded in authentication”). Specifically, the authentication unit 302 transmits a positive response including the number of persons who have succeeded in authentication to the gate apparatus 10.

For example, in a case where an authentication request including biometric information (face images) of two persons is received and authentication is successful for the two persons, the authentication unit 302 transmits a positive response including “2” as the number of persons who have succeeded in authentication to the gate apparatus 10. Alternatively, in a case where an authentication request including biometric information (face images) of two persons is received and authentication is successful for one person, the authentication unit 302 transmits a positive response including “1” as the number of persons who have succeeded in authentication to the gate apparatus 10.

The authentication control unit 204 of the gate apparatus 10 processes a response (a positive response, a negative response) to the authentication request. In a case where a negative response is received, the authentication control unit 204 does not perform any particular processing. In a case where a positive response is received, the authentication control unit 204 adds the number of persons who have succeeded in authentication, included in the positive response, to the number of persons permitted to pass through the gate.

As described above, the gate apparatus 10 according to the second example embodiment transmits to the server apparatus 20 an authentication request including authentication information of each of a plurality of users who attempt to enter the interior of the gate apparatus 10. At the time of responding to the authentication request, the server apparatus 20 notifies the gate apparatus 10 of the number of persons who have succeeded in authentication, acquired based on the respective authentication results of the plurality of users. With such a configuration, the number of communications and the amount of communication between the gate apparatus 10 and the server apparatus 20 are reduced.

### Third Example Embodiment

Subsequently, a detailed description will be given of a third example embodiment with reference to the drawings.

In the second example embodiment, it is described that an authentication request is transmitted collectively for a plurality of users who have arrived at the entrance of the gate apparatus 10 at the same timing. In the third example embodiment, it will be explained that an authentication request including biometric information of the plurality of users and image data in which the whole body (a face region and a non-face region) of the person to be authenticated appears is transmitted.

It should be noted that a configuration of the authentication system according to the third example embodiment can be the same as that of the first example embodiment, and therefore a description corresponding to FIG. 3 is omitted.

The following description will be made with a focus on the difference from the first example embodiment to the third example embodiment.

In a third example embodiment, in a case where two or more users simultaneously reach the entrance of the gate apparatus 10, the entering person detection unit 203 of the gate apparatus 10 passes not only the face images of the two or more users but also image data acquired from the camera 11 to the authentication control unit 204. For example, in a case where two users arrive side by side at the entrance (position X1) of the gate apparatus 10, the entering person detection unit 203 passes to the authentication control unit 204 the respective face images of the two users and the image data including the entirety (whole bodies) of the two users.

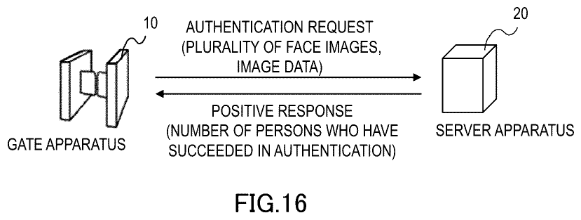

The authentication control unit 204, which has acquired a plurality of face images and image data, transmits an authentication request (a single authentication request) including the plurality of face images and the image data to the server apparatus 20 (see FIG. 16).

The authentication unit 302 of the server apparatus 20, in a case where an authentication request including a plurality of pieces of biometric information (face images) is received, performs authentication processing for each piece of the biometric information. In a case where, as a result of the authentication processing (biometric authentication), authentication fails for at least one person to be authenticated, the authentication unit 302 determines whether or not the person for whom authentication has failed (the person to be authenticated who has been determined as authentication failure) possesses legitimate authorization for passing through the gate.

The authentication unit 302, in a case where both a first user and a second user appear in the image data and authentication for the first user has failed, determines whether or not the first user and the second user have a predetermined relationship. In a case where it is determined that the first user and the second user have the predetermined relationship, the authentication unit 302 regards the first user, for whom authentication has failed, as having successfully authenticated by using the authentication information.

Specifically, the authentication unit 302 uses the image data included in the authentication request to determine the presence or absence of the predetermined relationship and whether or not the person for whom authentication has failed possesses authorization.

For example, the authentication unit 302 determines whether or not a person with a disability (for instance, a user in a wheelchair) appears in the image data. For example, the authentication unit 302 determines the presence or absence of the person with a disability by inputting the image data into a learning model obtained through machine learning. The authentication unit 302 outputs the face image of the person with a disability by inputting the image data into the learning model.

It should be noted that the above-described learning model can be obtained by machine learning using a large amount of image data labeled with the presence or absence of a person with a disability as training data. Any algorithm such as a support vector machine, boosting, or a neural network can be used to generate the learning model. It should be noted that the above algorithms such as the support vector machine are known techniques and therefore their description is omitted.

In a case where the person with a disability appears in the image data, the authentication unit 302 performs authentication processing again using the face image obtained from the learning model. In a case where authentication is successful for the person with a disability (a user presumed to be a person with a disability) appearing in the image data, the authentication unit 302 determines whether or not a disability certificate has been issued to the person with a disability.

Here, in the biometric information management database according to the third example embodiment, it is stored whether or not each user is recognized as a “person with a disability” by a public institution. That is, the biometric information management database stores whether or not each user holds a disability certificate or the like.

The authentication unit 302, in a case where a user (a user presumed to be a person with a disability) identified by the matching process has been issued a disability certificate, determines that an accompanying caregiver also possesses legitimate authorization for passing through the gate together with the person with a disability who has been successfully authenticated. That is, in a case where authentication is successful for a person to be authenticated who holds a disability certificate, the authentication unit 302 determines that one caregiver, in addition to the person to be authenticated who holds the disability certificate, has authorization for passing through the gate.

As described above, the authentication unit 302, even in a case where a user has not purchased a ticket or the like, treats the user as having successfully authenticated in a case where the user is recognized as a caregiver for a person with a disability. That is, even in a case where authentication fails for one of the two persons to be authenticated (a user having a relationship of a person with a disability and a caregiver), if authentication is successful for the person to be authenticated who holds a disability certificate, the authentication unit 302 treats the person to be authenticated for whom authentication has failed (the caregiver) as having successfully authenticated.

In this case, the authentication unit 302 transmits a positive response to the gate apparatus 10, in which the number of persons successfully authenticated is set to “2”.

It should be noted that, in a case where the person with a disability and the caregiver have authorization for passing through the gate (for example, in a case where tickets have been purchased), authentication for the person with a disability and the caregiver is successful, and therefore, determination of their relationship or the like using the above-described image data is not performed.

Alternatively, the authentication unit 302 may determine whether or not a guardian accompanied by a preschool child appears in the image data. In this case as well, the authentication unit 302 uses a learning model obtained through machine learning. The authentication unit 302 acquires a face image of the guardian accompanied by the preschool child by inputting the image data into the learning model. Alternatively, the authentication unit 302 may determine whether or not the user is the preschool child by using the height of the user.

The authentication unit 302 performs authentication processing again for the face image obtained from the learning model (the face image of the guardian accompanied by the preschool child). In a case where authentication is successful for the guardian, the authentication unit 302 determines that the preschool child also possesses authorization for passing through the gate together with the guardian who has been successfully authenticated.

As described above, the authentication unit 302, even in a case where a user has not purchased a ticket or the like, treats the user as having successfully authenticated in a case where the user is recognized as a preschool child accompanied by a guardian. That is, regarding two persons to be authenticated (users having a relationship of a guardian and a preschool child), even in a case where authentication fails for one person to be authenticated (the preschool child), if authentication is successful for the guardian, the authentication unit 302 treats the person to be authenticated for whom authentication has failed (the preschool child) as having successfully authenticated. In this case, the authentication unit 302 transmits a positive response to the gate apparatus 10, in which the number of persons successfully authenticated is set to “2”.

It should be noted that, even if the user is a preschool child, the preschool child cannot pass through the gate apparatus 10 without being accompanied by a guardian.

As described above, the authentication system according to the third example embodiment treats as successfully authenticated a person for whom authentication has failed (a caregiver, a preschool child) who acts together with a person for whom authentication has succeeded (a person with a disability, a guardian). The guardian or the like accompanied by the preschool child can enter the ticket gate area without having to go to a station staff member, thereby improving the convenience of the guardian or the like.

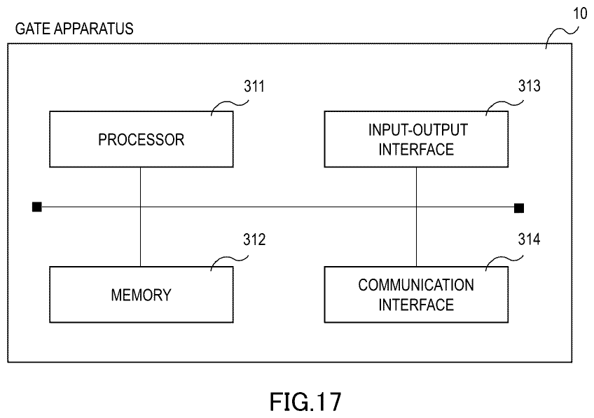

Next, a hardware configuration of an individual apparatus that constitutes the information processing system will be described. FIG. 17 is a diagram illustrating an example of a hardware configuration of the gate apparatus 10 (passage control apparatus).

The gate apparatus 10 can be configured to include an information processing apparatus (a so-called computer), and includes the configuration exemplified in FIG. 17. For example, the gate apparatus 10 includes a processor 311, a memory 312, an input-output interface 313, a communication interface 314, and the like. The components such as the processor 311 are connected to an internal bus, and so on so that these components can communicate with each other. It should be noted that in FIG. 17, illustration of the camera 11, the gate 12, the reader 13, and the like is omitted.

However, the configuration shown in FIG. 17 is not intended to limit the hardware configuration of the gate apparatus 10. The gate apparatus 10 may include hardware not illustrated, and may not include the input-output interface 313 as necessary. In addition, the number of components such as the processor 311 included in the gate apparatus 10 is not intended to be limited to the example shown in FIG. 17, and for example, a plurality of processors 311 may be included in the gate apparatus 10.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), and the like. The memory 312 stores an OS program, an application program, and various kinds of data.

The input-output interface 313 is an interface for a display apparatus and an input apparatus, which are not illustrated. The display apparatus is, for example, a liquid crystal display or the like. For example, the input apparatus is an apparatus that receives user operations, and examples of the input apparatus include a keyboard and a mouse.

The communication interface 314 is a circuit, a module, or the like for performing communication with other apparatuses. For example, the communication interface 314 includes a NIC (Network Interface Card) or the like.

The functions of the gate apparatus 10 (passage control apparatus) are implemented by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

It should be noted that the server apparatus 20 can each be configured by an information processing apparatus, and the basic hardware configuration of the server apparatus 20 is the same as that of the gate apparatus 10. Thus, description of the basic hardware configuration of the server apparatus 20 will be omitted.

The gate apparatus 10 (passage control apparatus), which includes an information processing apparatus, is provided with a computer, and the functions of the gate apparatus 10 can be implemented by causing the computer to execute a program. In addition, the gate apparatus 10 executes a control method of the gate apparatus 10 by using the program.

### Variations

It should be noted that the configurations, operations, and the like of the authentication system described in the above example embodiment are merely examples and are not intended to limit the configuration or the like of the system.

In the above example embodiments, the gate apparatus 10 (passage control apparatus) has been described as a ticket gate installed in a station. However, it goes without saying that the gate apparatus 10 is not intended to be limited to a ticket gate. The gate apparatus 10 may be any apparatus installed in an airport, event venue, office, or the like that controls passage of users.

In the above example embodiments, a case has been described in which the server apparatus 20 has a user information database. However, the database may be constructed on a database server different from the server apparatus 20. In addition, the authentication system only needs to include various means described in the above example embodiments (for example, the authentication unit 302 or the like). For example, a part of the processing to be performed by the gate apparatus 10 may be performed by the server apparatus 20. A part or all of the functions of the gate apparatus 10 may be implemented by the server apparatus 20.

In the above example embodiments, a case has been described in which biometric information related to a face image is transmitted from the gate apparatus 10 to the server apparatus 20. However, a feature value generated from the face image may be transmitted as biometric information from the gate apparatus 10 to the server apparatus 20.

In the above example embodiments, it is assumed that the camera 11 is a monocular camera; however, the camera 11 may be a depth camera (stereo camera) capable of measuring in the depth direction. In this case, the gate apparatus 10 may detect a user who has arrived at a predetermined position by using an image obtained from the stereo camera. Specifically, the gate apparatus 10 analyzes two images obtained from the stereo camera (analysis using parallax) and calculates the position of the user with reference to the gate apparatus 10.

The data exchange mode between the individual gate apparatus 10 and the server apparatus 20 is not limited to a particular mode. The data exchanged between these apparatuses may be encrypted. Face images and feature values calculated from these face images are personal information, and to appropriately protect the personal information, it is desirable that encrypted data be exchanged.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to an authentication system installed in an airport, a station, or the like.

A part or the entirety of the example embodiments described above may be described as in the following supplementary notes, but is not limited to the followings.

### Supplementary Note 1

A passage control apparatus, including:
a detection means that detects a plurality of users attempting to enter an interior of the passage control apparatus by using image data acquired by capturing an image of the plurality of users attempting to enter the interior;
an authentication control means that performs control related to authentication for each of the detected plurality of users;
a determination means that determines, based on respective authentication results of the plurality of users, whether or not the plurality of users who have entered the interior are permitted to pass through the passage control apparatus; and
a control means that denies passage of the plurality of users who have entered the interior, in a case where it is determined that at least one or more of the plurality of users who have entered the interior are not permitted to pass through the passage control apparatus.

### Supplementary Note 2

The passage control apparatus according to supplementary note 1, wherein the determination means determines whether or not the plurality of users who have entered the interior are permitted to pass through the passage control apparatus, based on a number of users who have entered the interior and a number of users determined as authentication success.

### Supplementary Note 3

The passage control apparatus according to supplementary note 2, wherein the detection means detects the plurality of users attempting to enter the interior, based on indexes indicating a size of a face region, the face region being included in the image data, of each of the plurality of users attempting to enter the interior.

### Supplementary Note 4

The passage control apparatus according to supplementary note 3, wherein the plurality of users attempting to enter the interior arrive at an entrance at substantially same timing, and arrive at a gate installed in the passage control apparatus at substantially same timing.

### Supplementary Note 5

The passage control apparatus according to supplementary note 4, wherein the authentication control means transmits to a server apparatus, the server apparatus performing a biometric authentication, an authentication request including authentication information of each of the plurality of users attempting to enter the interior.

### Supplementary Note 6

The passage control apparatus according to supplementary note 5, wherein the authentication control means transmits to the server apparatus the authentication request including the authentication information of each of the plurality of users attempting to enter the interior and the image data.

### Supplementary Note 7

A system, including:
a server apparatus performing an authentication processing; and
a passage control apparatus,
wherein the passage control apparatus, including:
a detection means that detects a plurality of users attempting to enter an interior of the passage control apparatus by using image data acquired by capturing an image of the plurality of users attempting to enter the interior;
an authentication control means that performs control related to authentication for each of the detected plurality of users;
a determination means that determines, based on respective authentication results of the plurality of users, whether or not the plurality of users who have entered the interior are permitted to pass through the passage control apparatus; and
a control means that denies passage of the plurality of users who have entered the interior, in a case where it is determined that at least one or more of the plurality of users who have entered the interior are not permitted to pass through the passage control apparatus.

### Supplementary Note 8

The system according to supplementary note 7, wherein the authentication control means transmits to the server apparatus an authentication request including authentication information of each of the plurality of users attempting to enter the interior and the image data, and
wherein the server apparatus:
performs the authentication processing using the authentication information of each of the plurality of users;
determines, in a case where the server apparatus fails to authenticate at least a first user among the plurality of users, whether or not the first user and a second user, the second user appearing together with the first user in the image data, have a predetermined relationship; and
regards, in a case where it is determined that the first user and the second user have the predetermined relationship, the first user as having successfully authenticated.

### Supplementary Note 9

A control method of a passage control apparatus, the control method including:
detecting a plurality of users attempting to enter an interior of the passage control apparatus by using image data acquired by capturing an image of the plurality of users attempting to enter the interior;
performing control related to authentication for each of the detected plurality of users;
determining, based on respective authentication results of the plurality of users, whether or not the plurality of users who have entered the interior are permitted to pass through the passage control apparatus; and
denying passage of the plurality of users who have entered the interior, in a case where it is determined that at least one or more of the plurality of users who have entered the interior are not permitted to pass through the passage control apparatus.

### Supplementary Note 10

A computer-readable storage medium storing a program causing a computer mounted on a passage control apparatus to perform processing for:
detecting a plurality of users attempting to enter an interior of the passage control apparatus by using image data acquired by capturing an image of the plurality of users attempting to enter the interior;
performing control related to authentication for each of the detected plurality of users;
determining, based on respective authentication results of the plurality of users, whether or not the plurality of users who have entered the interior are permitted to pass through the passage control apparatus; and
denying passage of the plurality of users who have entered the interior, in a case where it is determined that at least one or more of the plurality of users who have entered the interior are not permitted to pass through the passage control apparatus.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and spirit of the present invention. That is, the present invention of course includes various variations and modifications that could be made by those skilled in the art in accordance with the overall disclosure including the claims and the technical concept.

### REFERENCE SIGNS LIST

10 gate apparatus
10-1 gate apparatus
10-2 gate apparatus
10-3 gate apparatus
11 camera
12 gate
13 reader
20 server apparatus
100 passage control apparatus
101 detection means
102 authentication control means
103 determination means
104 control means
201 communication control unit
202 reader control unit
203 entering person detection unit
204 authentication control unit
205 gate passage permission determination unit
206 gate control unit
207 gate passer detection unit
208 storage unit
301 communication control unit
302 authentication unit
311 processor
312 memory
313 input-output interface
314 communication interface

What is claimed is:

1. A passage control apparatus, comprising:
at least one memory storing a set of instructions; and
at least one processor configured to execute the set of instructions to:
detect a plurality of users attempting to enter an interior of the passage control apparatus by using image data acquired by capturing an image of the plurality of users attempting to enter the interior;
perform control related to authentication for each of the detected plurality of users;
determine, based on respective authentication results of the plurality of users, whether or not the plurality of users who have entered the interior are permitted to pass through the passage control apparatus; and
deny passage of the plurality of users who have entered the interior, in a case where it is determined that at least one or more of the plurality of users who have entered the interior are not permitted to pass through the passage control apparatus.

2. The passage control apparatus according to claim 1, wherein the at least one processor is further configured to execute the set of instructions to determine whether or not the plurality of users who have entered the interior are permitted to pass through the passage control apparatus, based on a number of users who have entered the interior and a number of users determined as authentication success.

3. The passage control apparatus according to claim 2, wherein
the at least one processor is further configured to execute the set of instructions to detect the plurality of users attempting to enter the interior, based on indexes indicating a size of a face region, the face region being included in the image data, of each of the plurality of users attempting to enter the interior.

4. The passage control apparatus according to claim 3, wherein the plurality of users attempting to enter the interior arrive at an entrance at substantially same timing, and arrive at a gate installed in the passage control apparatus at substantially same timing.

5. The passage control apparatus according to claim 4, wherein
the at least one processor is further configured to execute the set of instructions to transmit to a server apparatus, the server apparatus performing a biometric authentication, an authentication request including authentication information of each of the plurality of users attempting to enter the interior.

6. The passage control apparatus according to claim 5, wherein
the at least one processor is further configured to execute the set of instructions to transmit to the server apparatus the authentication request including the authentication information of each of the plurality of users attempting to enter the interior and the image data.

7. A system, comprising:
a server apparatus performing an authentication processing; and
a passage control apparatus,
wherein the passage control apparatus, comprising:
at least one memory storing a set of instructions; and
at least one processor configured to execute the set of instructions to:
detect a plurality of users attempting to enter an interior of the passage control apparatus by using image data acquired by capturing an image of the plurality of users attempting to enter the interior;
perform control related to authentication for each of the detected plurality of users;
determine, based on respective authentication results of the plurality of users, whether or not the plurality of users who have entered the interior are permitted to pass through the passage control apparatus; and
deny passage of the plurality of users who have entered the interior, in a case where it is determined that at least one or more of the plurality of users who have entered the interior are not permitted to pass through the passage control apparatus.

8. The system according to claim 7, wherein
the at least one processor is further configured to execute the set of instructions to transmit to the server apparatus an authentication request including authentication information of each of the plurality of users attempting to enter the interior and the image data, and
wherein the server apparatus:
performs the authentication processing using the authentication information of each of the plurality of users;
determines, in a case where the server apparatus fails to authenticate at least a first user among the plurality of users, whether or not the first user and a second user, the second user appearing together with the first user in the image data, have a predetermined relationship; and
regards, in a case where it is determined that the first user and the second user have the predetermined relationship, the first user as having successfully authenticated.

9. A control method of a passage control apparatus, the control method comprising:
detecting a plurality of users attempting to enter an interior of the passage control apparatus by using image data acquired by capturing an image of the plurality of users attempting to enter the interior;
performing control related to authentication for each of the detected plurality of users;
determining, based on respective authentication results of the plurality of users, whether or not the plurality of users who have entered the interior are permitted to pass through the passage control apparatus; and
denying passage of the plurality of users who have entered the interior, in a case where it is determined that at least one or more of the plurality of users who have entered the interior are not permitted to pass through the passage control apparatus.

10. (Canceled)
